(19) United States
(12) Patent Application Publication
(10) Pub. No.: US 2002/0132616 A1
(43) Pub. Date: Sep. 19, 2002

(54) Communications system with automatic download capability

(76) Inventors: Lorna R. Ross, Los Angeles, CA (US); Matthias Richter, Milan (IT); Robert S. Gelick, Evanston, IL (US)

Correspondence Address: Motorola, Inc., Randall S. Vaas - AN475, Intellectual Property Dept. (BMM), 600 North US Highway 45, Libertyville, IL, 60048, US

(21) Appl. No.: 09/812,193

(22) Filed: Mar. 19, 2001

(51) Int. Cl. H04M 3/00

(52) U.S. Cl. 455/419; 455/418; 455/517

(57) ABSTRACT

An apparatus and method is provided for a communication system with automatic download capability from a service provider network. The downloaded content is tailored depending on local conditions. Local parameters defined by the local conditions are coded and input. User preferences defining a content profile for a user are stored in a memory file and are coder per the local parameters. The local parameters automatically key the user preferences for use as a search engine filter to find content associated with the local conditions. Any found content is automatically downloaded to the communication device to be played back to the user via a user interface.

### FIELD OF THE INVENTION

The present invention relates generally to communication systems. More particularly, the invention is directed to a downloading relation of a communication device and a service provider.

### BACKGROUND OF THE INVENTION

Wireless communication technology, such as is used with cellular phones, is becoming much more sophisticated as the technology evolves. Presently, wireless communication systems and devices have the capability to not only provide communication between people, but also can acquire and provide different types of content including Internet web pages, FM radio, and application software such as games, for example. As a result, users are increasing the amount of time using wireless communication systems and increasing the amount of interaction with the communication device.

As an example, it is possible to download music files from the Internet and listen to the recorded music over cellular telephones. However, this action involves a conscious effort on the part of a user to locate, obtain and play such files. There is an issue of privacy when playing such files. A user typically will not want to disturb others around them when playing music, or may desire to keep their listening private. This would also apply to keeping conversations with other wireless users more private or to privately enjoy multimedia applications that could be displayed on a screen of the communication device while the user listens. At the present time, the only way to listen to music in a private manner is with headphones, either with in-the-ear earbuds or around-the-ear enclosed speaker cups. Headphones are also the only means to provide adequate fidelity when listening

What is needed is a method and apparatus to provide a substantially hands-off user interface for a communication device. It would be an advantage to have the user interface be comfortable so that it can be utilized over an extended time period in comfort. Further, it would be an advantage to have the device provide a private environment. It would also be of benefit for the communication device to tailor the content provided to the user interface depending on the local conditions. Specifically, a benefit would be achieved if the content were automatically personalized to the user.

### BRIEF DESCRIPTION OF THE DRAWINGS

FIG. 1 illustrates a simplified block diagram of a communication system, in accordance with the present invention;

FIGS. 2-5 illustrates different embodiments of a user interface, in accordance with the present invention;

FIG. 2 illustrates a scarf implementation, in a general use position;

FIG. 3 illustrates the scarf implementation of FIG. 2, in a privacy position;

FIG. 4 illustrates a collar implementation;

FIG. 5 illustrates hood implementation; and

FIG. 6 is a flow chart illustrating a method of content downloading, in accordance with the present invention.

### DETAILED DESCRIPTION OF THE PREFERRED EMBODIMENTS

The present invention provides a method and apparatus that provides a substantially hands-off user interface for a communication device. The user interface is comfortable so that it can be utilized over an extended time period in comfort, and can provide a private environment. The communication device tailors the content provided to the user interface depending on the local conditions. Specifically, the content can be automatically personalized to the user depending on local conditions, such as a location or mood of the user, for example.

The invention will have application apart from the preferred embodiments described herein, and the description is provided merely to illustrate and describe the invention and it should in no way be taken as limiting of the invention. While the specification concludes with claims defining the features of the invention that are regarded as novel, it is believed that the invention will be better understood from a consideration of the following description in conjunction with the drawing figures, in which like reference numerals are carried forward. As defined in the invention, a radiotelephone is a communication device that communicates information to a base station using electromagnetic waves in the radio frequency range. In general, the radiotelephone is portable and is able to receive and transmit. However, the present invention is equally adaptable to any communication device and user interface, be they wireless or wireline.

The concept of the present invention can be advantageously used on any electronic product with data transfer. Preferably, the radiotelephone portion of the communication device is a cellular radiotelephone adapted for personal communication, but may also be a pager, cordless radiotelephone, or a digital communication cellular radiotelephone. The radiotelephone portion is constructed in accordance with a known communication standard, such as the DCS, PCS, GSM, CDMA or TDMA standards as are known in the art, or future digital communication standards that are presently being developed. The radiotelephone portion generally includes a radio frequency (RF) transmitter, an RF receiver, memory, a digital signal processor, and a microprocessor. The radiotelephone portion can also include a paging receiver. The electronics incorporated into a cellular phone, two-way radio or selective radio receiver, such as a pager, are well known in the art, and can be incorporated into the communication device of the present invention.

Many types of digital communication devices can use the present invention to advantage. By way of example only, the communication device is embodied in a cellular phone having a conventional cellular radio transceiver circuitry, as is known in the art, and will not be presented here for simplicity. The cellular telephone, includes conventional cellular phone hardware (also not represented for simplicity) such as processors and user interfaces that are integrated in a compact housing, and further includes microprocessing and digital processing circuitry, in accordance with the present invention. Each particular wireline or wireless device will offer opportunities for implementing this concept and the means selected for each application.

A series of specific embodiments are presented, ranging from the abstract to the practical, which illustrate the application of the basic precepts of the invention. Different embodiments will be included as specific examples. Each of which provides an intentional modification of, or addition to, the method and apparatus described herein.

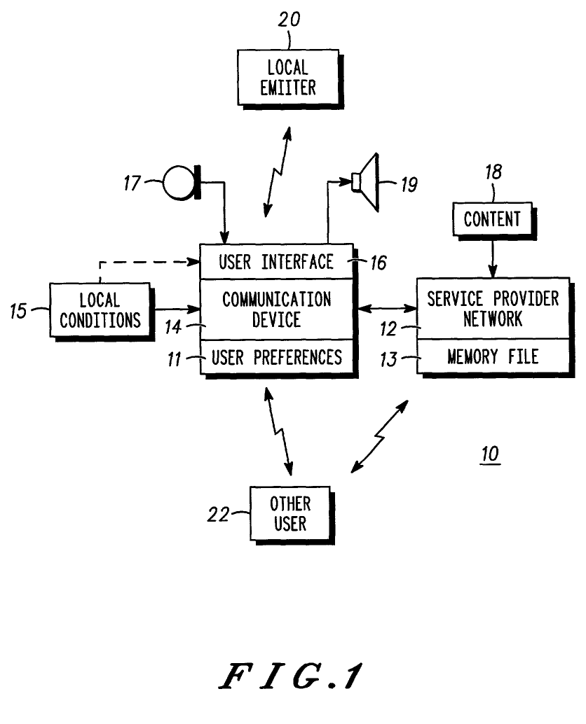

Referring to FIG. 1, the present invention is a communication system 10 including a service provider network 12 and a communication device 14 with a user interface and transceiver circuitry in the communication device 14, the communication device 14 is operable to download content 18 from the service provider network 12, to be provided to the user interface 16, that is tailored depending on local conditions 15.

A novel aspect of the present invention is the automatic downloading and playing of content to a user depending on local conditions. These local conditions are reduced to local parameters or input and can include, but are not limited to; a user's geographic location, a user's location in relation to other users and in particular those users with similar interests, and a user's desires or intent determined either explicitly or implicitly.

In a first embodiment of the present invention, the content 18 includes music files that are automatically and dynamically downloaded and played to a user depending on predetermined user preferences and local parameters. The user preferences provide specific audio profiling for the user as a function of the local parameters. The user preferences 11 are pre-stored, such as in a memory file 13, either on the communication device 14 or remotely on the network 12 and are coded per the local parameters. Specifically, the user preferences are identifiers or terms used in a search engine or as a filter to download desired content, and are keyed by a coded input defined by the local parameters. The local parameters are input and coded by the communication device, either directly or through the user interface 16 or another interface device. The coded input is sent to the memory file 13 to key the search engine or filter to find the content associated with the coded input of the local conditions. In particular, the local parameters defining the coded input can include, but are not limited to; an explicit command from the user that can include a voice command (e.g. “I want to listen to some classical music”) or command entered on any other input interface of the communication device such as a keypad, touch screen, and the like included in the user interface 16; an implicit command derived from a physical sensor in the user interface 16 that is located on the user's person, indicative of a user's mood, such as a detection of increased heart rate (requesting more soothing music), perspiration rate (requesting more active music for exercising), blood pressure, or other biofeedback mechanism that could be used to trigger a command to the memory file; driven by a time cue, such as particular music at particular times of the day or days of the week, for example; and geographic location (“When I'm in an airport I like classical music”) that can be determined through a location device such as a Global Positioning System (GPS) tracker in the communication device 14 or local emitters 20 at particular locations, each of which can be linked with a stored preference map. Once the content is found it is automatically downloaded to the communication device 14 and automatically played back to the user. Optionally, the user preferences can be dynamically updated such as to change delivered content as a function of what had previously been downloaded during periods or locations having similar local conditions.

Along these same lines, local content emitters 20 at particular geographic locations (such as stores or other public places, for example) can provide remote downloads of content when a user is within their proximity, and “push” content to the user if the content aligns with the user preferences for content. In order to realize this, the content of the local emitters 20 would be labeled with attributes that can be matched or compared, similar to a search engine filter, with a similar profile of user preferences 11 that are stored in a communication device 14 of a user located near the emitter 20.

Even further along these lines users themselves 14 can act as local emitters and can share content downloads with other users 22 near their location. This can be accomplished either by transmission of attributes to match other nearby receptive users 22 or through the use of GPS or other location determining technique, wherein a remote network 12 can detect when users 14,22 with similar user profiles are in proximity to each other and alert those users of the availability of shared content downloads, either between users or with the network. This would depend upon any particular user having user preferences 11 stored in their communication device 14, wherein such preferences allow the user's communication device to be receptive to downloading from other users 22 or allowing the network 12 to indicate the proximity of other users 22 having similar profiles.

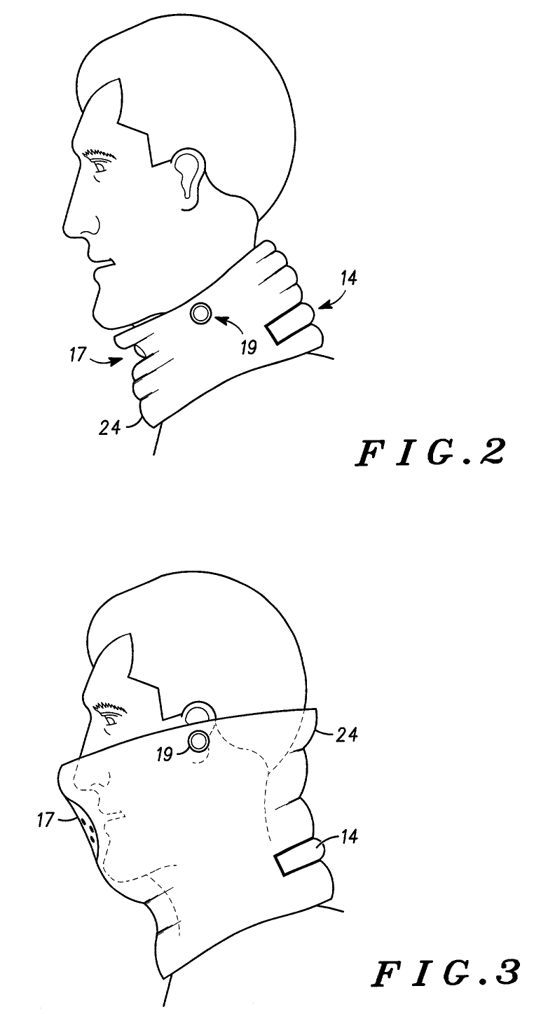

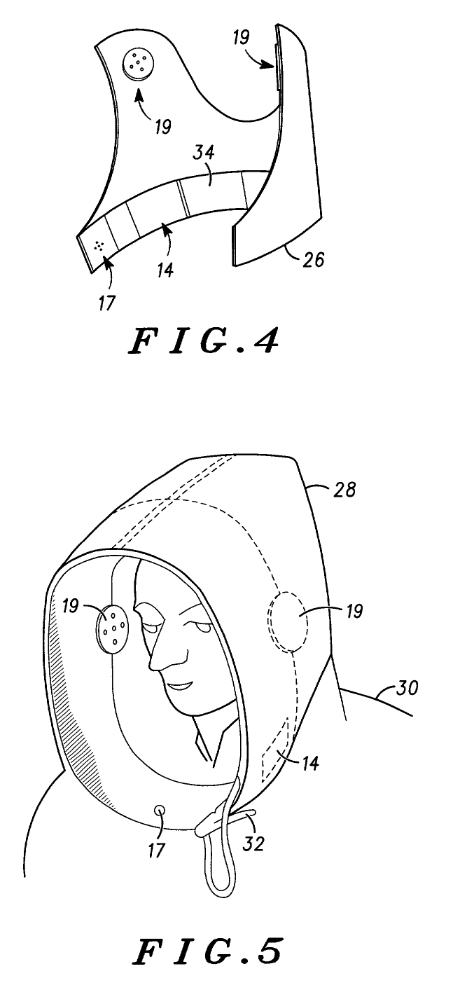

In practice, and referring to FIGS. 2 through 5, it is preferred that the user interface is incorporated into at least one speaker 19 that is worn on or near a user's head. In contrast to headphones, it is envisioned that wearable headgear or a headwear device, such as a neckband or scarf 24 (FIGS. 2 and 3), collar 26 (FIG. 4) or hood 28 (FIG. 5) be used to mount the at least one speaker 19. The headwear device can be coupled with a jacket 30 or other accessory, and can be shaped around a user's ears in different forms, from the equivalent to a scarf 24 or collar 26 around the neck to a substantially complete sphere around the user's head. A headwear device such as a hood 28 creates a private audio space around the ears of the user. The headwear device replaces the conventional earpieces or headphones used in portable audio equipment by providing improved audio quality in a non-intrusive and comfortable way. The headwear device can be comprised of a variety of material, from textiles to felt, and the like. In addition, the headwear device can be flexible to fit over a user's head (FIG. 2) and to provide some amount of conformal fit (FIG. 3) when pulled up to provide more privacy, or it can be of a non-flexible cloth that can provide a suitable volume of space around a user's head (FIG. 5). It is envisioned that the hood can be a fashion accessory that makes clearly visible the connection of a user to a wireless communication system. The at least one speaker 19 can easily be adapted to clip or snap onto the headwear at positions that abut, or are in proximity to, the ear. This capability makes is easy to assemble and disassemble the headwear for cleaning or replacing with a different fashion.

Preferably, the content is music and the headwear includes a provision for any one of the group of; two or more speakers 19 for stereo or surround music reproduction, a microphone 17 for communication; a personal light, video or gaming device, antenna, battery, and a wired or wireless remote control to adjust the functions of the present invention. The remote control can consist of the communication device 14 itself or be on a separate control fob 32. The remote control can be stored in a pouch of the hood, hung from the hood within easy grasp of the user or clipped on the clothing of the user. It should be recognized that the hood can also provide multimedia content wherein video can be downloaded and viewed on a display of the user interface of the communication device, on the control fob 32, or on another accessory such as glasses, hood display or virtual reality goggles, and the like, all controlled by the remote control. Further, the remote control could be used to record or edit music or video for downloading to other users or the network, to be shared or later downloaded by the user or other users.

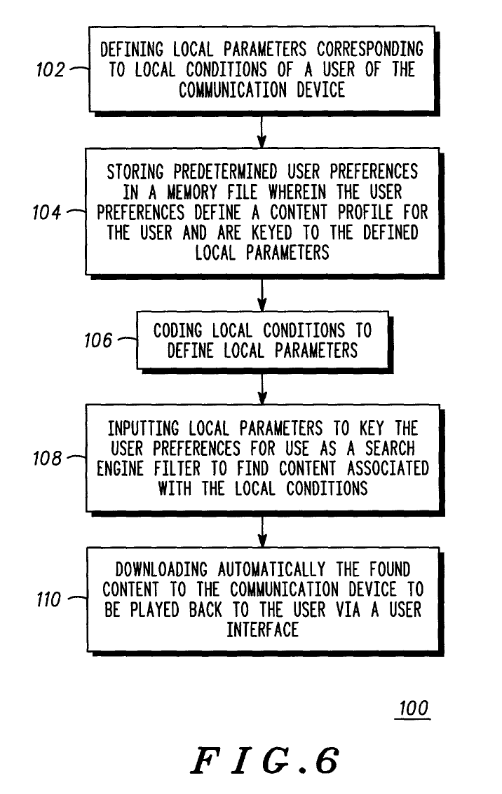

Referring to FIG. 6, the present invention also incorporates a method 100 for a service provider to automatically download content to a communication device for output to a user interface. Preferably, the content is music content. A first step 102 includes defining local parameters corresponding to local conditions of a user of the communication device. Preferably, this step includes local conditions selected from one of the group of a time cue, a user's geographic location, a user's location in relation to other users with similar user preferences, a user's explicit command, and a physical sensor on the to determine a physical parameter of the user. A next step 104 includes storing predetermined user preferences in a memory file wherein the user preferences define a content profile for the user and are keyed to the defined local parameters. A next step 106 includes coding local conditions to define local parameters. A next step 108 includes inputting local parameters to key the user preferences for use as a search engine filter to find content associated with the local conditions. A next step 110 includes automatically downloading the found content to the communication device to be played back to the user via a user interface.

In a preferred embodiment, the method includes a further step of providing local content emitters and other users, and wherein the downloading step 110 includes remote downloading of content when a user is in proximity to the local content emitters and other users and aligns with the user preferences for content. Further, the storing step 104 can include storing the user preferences in the communication device, and can further comprise the steps of determining locations of users with similar user preferences in proximity to each other, and allowing the users to share content.

In practice, the method 100 includes a further step of providing a headwear device, such as a scarf, band, collar, or hood incorporating at least one speaker, and preferably two speakers, that is worn in proximity to a user's head.

The present invention provides a method and apparatus that provides a communication device with a unique wearable interface that automatically tailors multimedia content to match a user's intent or mood depending on the local conditions that a users may find themselves in. The content is automatically personalized to the user to provide optimum enjoyment and productivity as a function of various local conditions and environments. Moreover, a user can interact with other local users or entities that share similar tastes.

While the foregoing described embodiments have been set forth above, it will be appreciated to one skilled in the art that the invention described has applications beyond the described embodiments. Accordingly, it is intended that the scope of the invention including such alternatives, modifications, and variations contemplated shall be defined by the appended claims.

What is claimed is:

1. A communication system including a service provider network and a communication device with a user interface and transceiver circuitry, the communication device is operable to download content from the service provider network, to be provided to the user interface, that is tailored depending on local conditions, the communication system comprising:
local parameters defining the local conditions of a user of the communication device; and
predetermined user preferences defining a content profile for the user, the user preferences are stored in a memory file and are coder per the local parameters, wherein local parameters that are input will automatically key the user preferences for use as a search engine filter to find content associated with the local conditions, wherein found content is automatically downloaded to the communication device to be played back to the user via the user interface.

2. The communication system of claim 1, wherein the memory file is stored on the service provider network and is used to dynamically download content from the service provider network to the user.

3. The communication system of claim 1, wherein the content includes one of the group of music and multimedia files.

4. The communication system of claim 1, wherein the local condition includes one of the group of a time cue, a user's geographic location, a user's location in relation to other users with similar user preferences, a user's explicit command, and a user's implicit command determine from user interface input.

5. The communication system of claim 4, wherein the implicit command is determined by a physical sensor on the user.

6. The communication system of claim 1, wherein the user preferences are dynamically updated to change delivered content as a function of previously downloaded content under similar local conditions.

7. The communication system of claim 1, further comprising local content emitters that provide remote downloads of content when a user is in proximity to the local content emitters and aligns with the user preferences for content.

8. The communication system of claim 1, wherein the user preferences are stored in the communication device, and an other user can provide remote downloads of content when a user is in proximity to the other user and the other user shares similar user preferences for content.

9. The communication system of claim 1, wherein the user preferences are stored in the communication device, and the service provider network determines locations of users with similar user preferences in proximity to each other and allows the users to share content.

10. The communication system of claim 1, further comprising a headwear device incorporating at least one speaker that is worn in proximity to a user's head.

11. The communication system of claim 10, wherein the headwear device includes audio and video accessories and controls and provides a privacy mode of operation.

12. The communication system of claim 11, wherein the headwear device further comprises editing controls to edit audio or video files that can be downloaded to the network or other users.

13. A communication system including a service provider network and a communication device with a user interface and transceiver circuitry, the communication device is operable to download music content from the service provider network, to be provided to the user interface, that is tailored depending on local conditions, the communication system comprising:
local parameters defining the local conditions of a user of the communication device; and
predetermined user preferences defining a music content profile for the user, the user preferences are stored in a memory file on the service provider network and are coder per the local parameters, wherein local parameters that are input will automatically key the user preferences for use as a search engine filter to find music content associated with the local conditions, wherein found music content is automatically downloaded to the communication device to be played back to the user via the user interface.

14. The communication system of claim 13, wherein the local condition includes one of the group of a time cue, a user's geographic location, a user's location in relation to other users with similar user preferences, a user's explicit command, and a physical sensor on the to determine a physical parameter of the user.

15. The communication system of claim 13, further comprising local content emitters and other users that provide remote downloads of content when a user is in proximity to the local content emitters and other users and aligns with the user preferences for content.

16. The communication system of claim 13, wherein the user preferences are stored in the communication device, and the service provider network determines locations of users with similar user preferences in proximity to each other and allows the users to share content.

17. The communication system of claim 13, further comprising a headwear device incorporating at least one speaker that is worn in proximity to a user's head.

18. A method for a service provider to automatically download content to a communication device for output to a user interface, the method comprising the steps of:
defining local parameters corresponding to local conditions of a user of the communication device;
storing predetermined user preferences in a memory file wherein the user preferences define a content profile for the user and are keyed to the defined local parameters;
coding local conditions to define local parameters;
inputting local parameters to key the user preferences for use as a search engine filter to find content associated with the local conditions; and
downloading automatically the found content to the communication device to be played back to the user via a user interface.

19. The method of claim 18, wherein defining step includes local conditions selected from one of the group of a time cue, a user's geographic location, a user's location in relation to other users with similar user preferences, a user's explicit command, and a physical sensor on the to determine a physical parameter of the user.

20. The method of claim 18, further comprising the step of providing local content emitters and other users, and wherein the downloading step includes remote downloading of content when a user is in proximity to the local content emitters and other users and aligns with the user preferences for content.

21. The method of claim 18, wherein the storing step includes storing the user preferences in the communication device, and further comprising the steps of determining locations of users with similar user preferences in proximity to each other, and allowing the users to share content.

22. The method of claim 18, further comprising a step of providing a headwear device incorporating at least one speaker that is worn in proximity to a user's head.
